(19) United States
(12) Patent Application Publication
(10) Pub. No.: US 2024/0281040 A1
(43) Pub. Date: Aug. 22, 2024

(54) MAGNET ASSEMBLIES FOR OPENING DEVICE

(71) Applicant: Microsoft Technology Licensing, LLC, Redmond, WA (US)

(72) Inventors: Daniel Clark PARK, Woodinville, WA (US); Nicholas Benjamin WENDT, Seattle, WA (US); Brett Andrew TOMKY, Seattle, WA (US); Karsten AAGAARD, Monroe, WA (US); Denys V. YAREMENKO, Bellevue, WA (US)

(73) Assignee: Microsoft Technology Licensing, LLC, Redmond, WA (US)

(21) Appl. No.: 18/172,721

(22) Filed: Feb. 22, 2023

(51) Int. Cl. G06F 1/16; G09F 9/30; H04M 1/02

(52) U.S. Cl. CPC G06F 1/1681; G06F 1/1652; G09F 9/301; H04M 1/0206

(57) ABSTRACT

An apparatus allows a device to open from a closed configuration. The device comprises a first frame comprising a first magnet assembly, and a second frame rotatably coupled to the first frame. The apparatus comprises a second magnet assembly rotatably coupled to the second frame and configured to attract the first magnet assembly when the two frames and are in the closed configuration. A biasing member biases the second magnet assembly for rotation in an open direction. An actuator comprises first and second arms extending from an elongated base toward first and second cams that are coupled to the second magnet assembly. Translation of the elongated base toward the second magnet assembly causes the arms to rotate the cams, thereby causing rotation of the second magnet assembly in the open direction to reduce a magnetic force between the first magnet assembly and the second magnet assembly.

### BACKGROUND

In some devices, two frames or substrates are rotatably coupled to allow the frames/substrates to be rotated open and closed. A releasable latching mechanism is used to secure the device in a closed orientation.

### SUMMARY

According to one aspect of the present disclosure, an apparatus for allowing a device to open from a closed configuration is provided. The device comprises a first frame comprising a first magnet assembly, and a second frame rotatably coupled to the first frame. The apparatus comprises a second magnet assembly rotatably coupled to the second frame, with the second magnet assembly operatively configured to attract the first magnet assembly in the first frame when the first frame and the second frame are in the closed configuration.

A biasing member biases the second magnet assembly for rotation in an open direction. An actuator is mounted for translation relative to the second frame, with the actuator comprising a first arm extending from an elongated base toward a first cam coupled to the second magnet assembly, and a second arm laterally spaced from the first arm and extending from the elongated base toward a second cam coupled to the second magnet assembly. Translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly.

Another aspect provides foldable computing device that comprises a first frame comprising a first magnet assembly, and a second frame rotatably coupled to the first frame. The second frame comprises a second magnet assembly rotatably coupled to the second frame, with the second magnet assembly operatively configured to attract the first magnet assembly of the first frame when the first frame and the second frame are in the closed configuration.

A biasing member biases the second magnet assembly for rotation in an open direction. An actuator is mounted for translation relative to the second frame, with the actuator comprising a first arm extending from an elongated base toward a first cam coupled to the second magnet assembly, and a second arm laterally spaced from the first arm and extending from the elongated base toward a second cam coupled to the second magnet assembly. Translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly.

Another aspect provides a method for opening a device from a closed configuration, the device comprising a first frame comprising a first magnet assembly and a second frame rotatably coupled to the first frame. The method comprises translating an actuator mounted for translation relative to the second frame to cause a first arm extending from an elongated base of the actuator to contact and rotate a first cam coupled to the second magnet assembly, and cause a second arm laterally spaced from the first arm and extending from the elongated base to contact and rotate a second cam coupled to the second magnet assembly, thereby causing rotation of the second magnet assembly to reduce a magnetic force between the first magnet assembly and the second magnet assembly. The first frame is biased to rotate away from the second frame.

Another aspect provides a method for opening a device from a closed configuration and actuating a switch in the device, the device comprising a first frame comprising a first magnet assembly and a second frame rotatably coupled to the first frame and comprising a second magnet assembly, wherein a push-to-open button is moveably retained by the second frame. The method comprises translating the push-to-open button by a switch actuation distance to compress a plunger of the switch and actuate the switch. The push-to-open button is then further translated by an initial magnet rotation distance that rotates the second magnet assembly by an initial rotation. The switch plunger decompresses and further rotates the second magnet assembly beyond the initial rotation. And the first frame is biased to rotate away from the second frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1D show one example of a foldable computing device including an apparatus for allowing the device to open from a closed configuration according to examples of the present disclosure.

FIG. 2 is a partial cross-sectional view taken along line 2-2 of FIG. 1D showing a portion of the foldable computing device of FIGS. 1A-1D.

FIG. 3 shows a view of a first and second magnet assembly and actuator of the portion of the foldable computing device shown in FIG. 2.

FIG. 4 shows a bottom view of the second magnet assembly and actuator of FIG. 3.

FIG. 5 shows an exploded view of the apparatus frame, second magnet assembly and actuator of FIG. 4.

FIG. 6 shows a view of the apparatus frame of the apparatus shown in FIGS. 2-5.

FIG. 7 shows a top view of the apparatus frame, second magnet assembly, and actuator of FIG. 5.

FIG. 8 shows a partial view of the apparatus frame, a first cam and a first torsion spring.

FIG. 9 shows the second magnet assembly of FIGS. 2-6 according to examples of the present disclosure.

FIGS. 10 and 11 show schematic diagrams depicting one example of magnetic fields generated by the first magnet assembly and second magnet assembly that can be used in the foldable computing device of FIGS. 1A-1D.

FIG. 12 shows plots of torque as a function of a rotation angle for an example second magnet assembly comprising a Halbach array at two different angular configurations, and for a biasing spring according to examples of the present disclosure.

FIGS. 13-15 show partial side views of the actuator, first cam, and first magnet of the second magnet assembly at three different positions.

FIGS. 16-18 show the first magnet of the second magnet assembly at the three different positions relative to the first magnet of the first magnet assembly.

FIG. 19 is a schematic diagram showing the power button, corresponding switch, and actuator at different locations during user actuation of the push-to-open button.

FIG. 20 shows plots of torque as a function of a rotation angle for an example second magnet assembly and a biasing spring, and for the net torque of the second magnet assembly and biasing spring.

FIG. 21 shows plots of force as a function of a rotation angle for example cam reaction forces and a threshold switch force of the power button.

FIG. 22 shows a plot of the actuator stroke distance versus the push-to-open button stroke distance as the second magnet assembly is rotated.

FIG. 23 shows a top view of another example of an actuator of an apparatus for allowing the device to open from a closed configuration according to examples of the present disclosure.

FIG. 24 shows a block diagram of an example method for opening a device from a closed configuration according to examples of the present disclosure.

FIG. 25 shows a block diagram of an example method for opening a device from a closed configuration and actuating a switch in the device according to examples of the present disclosure.

### DETAILED DESCRIPTION

As introduced above, some devices include a first frame that is rotatably coupled to a second frame. For example, in a dual-screen smartphone or laptop, a first frame and a second frame may each house a touch screen display and may be rotatably coupled such that the two displays are movable with respect to one another. An attachment apparatus may secure the first frame and the second frame together in a closed orientation. In other examples, two rotatably coupled frames support a single flexible display that spans across the frames. A wide variety of other configurations and devices are also available.

In some instances, a device may use a mechanical latch and/or magnets to secure the movable frames together in the closed orientation. However, mechanical latches can require large footprints to accommodate moving parts. Mechanical interfaces also are subject to fatigue over time. Additionally, magnets that are strong enough to hold the device closed can occupy a large amount of packaging space and can be difficult to disengage when a user wishes to open the device. In some designs, mechanisms for moving the magnets can create sliding friction that further increase the force required to open the device.

To address these issues, examples are disclosed that relate to apparatus for allowing a device, such as a foldable computing device, to open from a closed configuration. As noted above, in one example a foldable computing device includes a first frame and a second frame rotatably coupled to the first frame. The first frame comprises a first magnet assembly and the second frame comprises a second magnet assembly. The second magnet assembly is rotatably coupled to the second frame and attracts the first magnet assembly of the first frame when the first frame and the second frame are in a closed configuration, thereby holding the two frames in the closed configuration. A biasing member biases the second magnet assembly for rotation in an open direction.

As described in more detail below, an actuator is mounted for translation relative to the second frame, with the actuator comprising a first arm extending from an elongated base toward a first cam coupled to the second magnet assembly, and a second arm laterally spaced from the first arm and extending from the elongated base toward a second cam coupled to the second magnet assembly. Translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly, and enabling the two frames to open. Advantageously and as described in more detail below, this configuration of the actuator and magnet assemblies provides stable and smooth operation of the actuator and user-actuated push-to-open button, allows larger magnet volumes to be utilized, and coordinates with a biasing member to provide a low-force actuation threshold for moving the button/actuator, along with other potential benefits described herein.

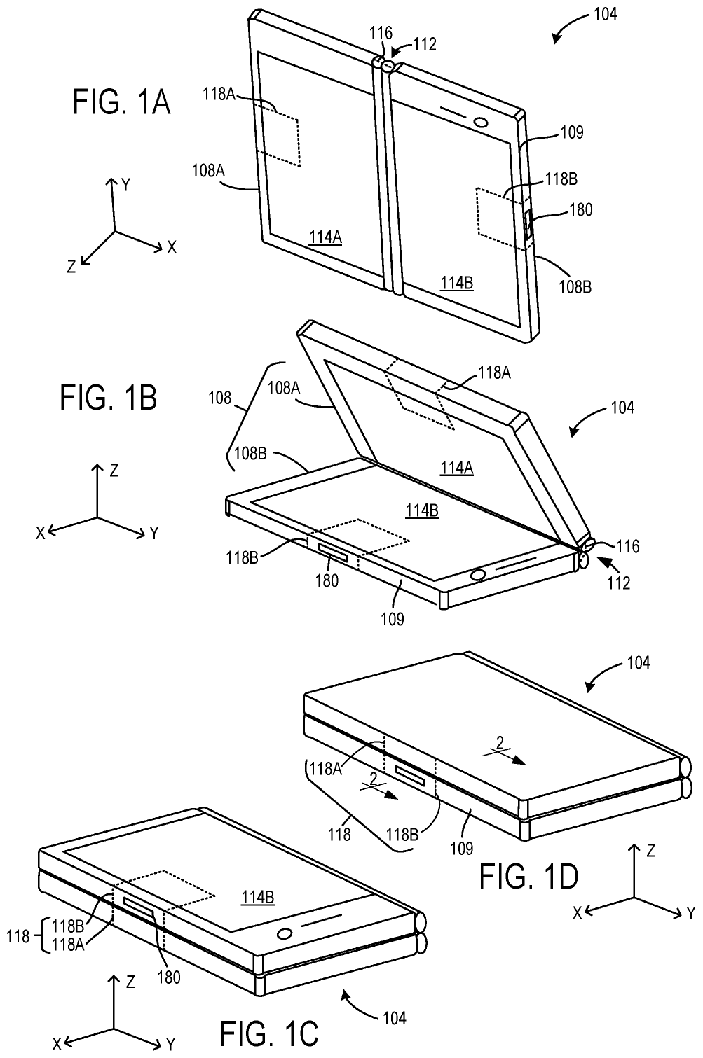

FIGS. 1A-1D show one example of a foldable computing device 104 in the form of a dual screen mobile computing device that can utilize apparatus of the present disclosure. In other examples, the foldable computing device may take the form of a laptop computing device, tablet computing device, or any other suitable computing device. It will also be appreciated that the apparatus and methods disclosed herein may also apply to any other suitable folding object.

In the example of FIGS. 1A-1D, the foldable computing device 104 includes a housing 108 having a first frame 108A and a second frame 108B rotatably coupled to the first frame via a hinge 112. The first frame 108A includes a display 114A and the second frame 108B includes a second display 114B. In this example, the first and second display are touch screen displays.

In the example of FIGS. 1A-1D, the first frame 108A and the second frame 108B are movable relative to each other. More particularly, the hinge 112 is configured to permit the first frame 108A and the second frame 108B to rotate 360 degrees between angular orientations from a closed configuration (FIG. 1D, also referred to as a face-to-face orientation) to a back-to-back orientation (FIG. 1C). In other examples, the first frame 108A and the second frame 108B are rotatable relative to one another over a range less than 360 degrees.

With reference now to FIG. 1B, the hinge 112 permits the first frame 108A and the second frame 108B to rotate relative to one another such that an angle between the frames 108A, 108B can be decreased or increased by the user applying suitable force to the housing 108 of the mobile computing device 104. From the angular orientation shown in FIG. 1B, the first frame 108A and the second frame 108B may be rotated until the displays 114A, 114B reach a back-to-back angular orientation as shown in FIG. 1C or the closed configuration as shown in FIG. 1D.

In some examples, the foldable computing device 104 further comprises a frame spring 116 that is operatively configured to bias the first frame 108A and the second frame 108B away from the closed configuration of FIG. 1C towards an open configuration. In the example of FIGS. 1A-1D, the frame spring 116 is located at the hinge 112. In this example, the frame spring 116 comprises a torsion spring that is operatively configured to apply a torque to the first frame 108A and the second frame 108B about the hinge 112 when the device 104 is in the closed configuration of FIG. 1D, with the torque biasing the first frame 108A and the second frame 108B towards the angular orientation shown in FIG. 1B. In this manner, the frame spring is operatively configured to bias open the foldable computing device.

In other examples, instead of or in addition to a frame spring, one or more other biasing components are provided to bias first and second frames away from the closed configuration. For example, in some examples of foldable computing devices that utilize a single flexible display spanning both frames, the flexible display also functions as a biasing component that biases the first and second frames away from the closed configuration.

As described in more detail below, and in one potential advantage of the present disclosure, the foldable computing device 104 further comprises an apparatus 118 for releasably securing the first frame 108A and the second frame 108B in the closed configuration shown in FIG. 1D. Additionally, in one potential advantage of the present disclosure, the apparatus 118 is operatively configured to allow users to easily open the foldable computing device from the closed configuration of FIG. 1D. As described in more detail below, the apparatus 118 comprises an actuator 120, a first portion 118A located at the first frame 108A, and a second portion 118B located at the second frame 108B. The actuator 120 is operatively configured to magnetically disengage the first portion 118A and the second portion 118B of the apparatus 118 to allow the foldable computing device to open from the closed configuration. Additional aspects of the actuator 120 and the apparatus 118 are described in more detail below.

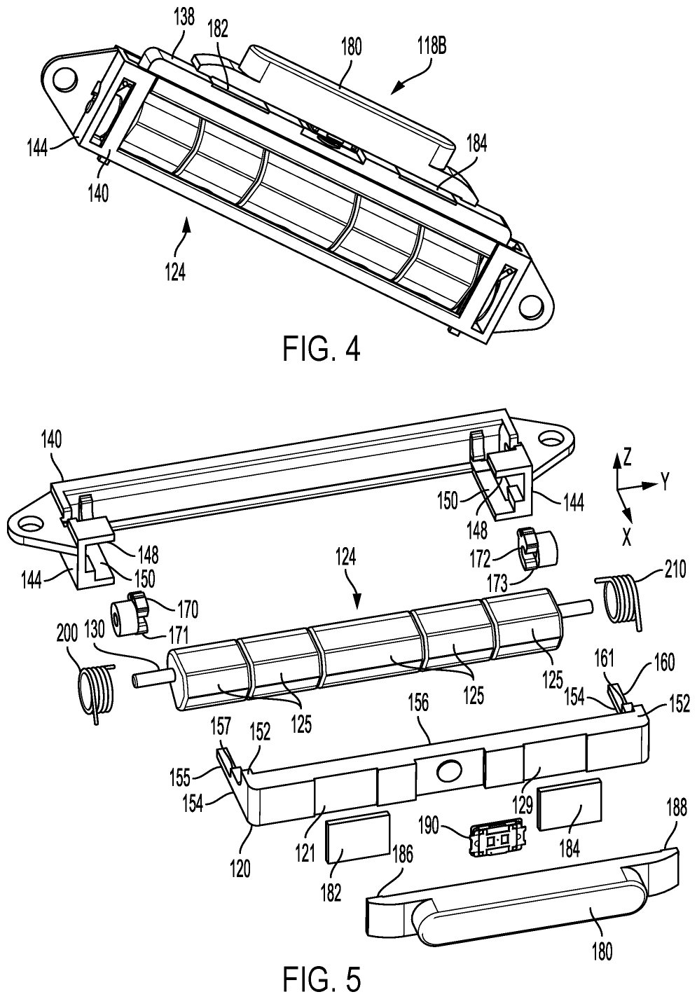

FIG. 2 shows a partial cross-sectional view of one example of the apparatus 118 of FIGS. 1A-1D taken along line 2-2 of FIG. 1D. As shown in FIGS. 2 and 3-6, the first portion 118A of the apparatus 118, located at the first frame 108A of the foldable computing device 104, comprises a first magnet assembly 122. The second portion 118B of the apparatus 118, located at the second frame 108B, comprises a second magnet assembly 124. The second magnet assembly 124 is operatively configured to attract the first magnet assembly 122 of the first frame 108A when the first frame 108A and the second frame 108B are in the closed configuration of FIG. 1D. In this manner, the first magnet assembly 122 and the second magnet assembly 124 are operatively configured to secure the first frame 108A and the second frame 108B together when the foldable computing device 104 is in the closed configuration.

With reference again to FIGS. 1D and 2, when the device is in the closed configuration, in this example the first magnet assembly 122 and the second magnet assembly 124 are separated by the display 114A and the second display 114B. In other examples, the first magnet assembly 122 may contact the second magnet assembly 124 in the closed configuration (e.g., where first and second displays 114A, 114B do not extend between the magnet assemblies). In these examples, the device may enable the use of smaller magnets and smaller motions to disengage the magnets relative to the use of magnets separated by other components of the device, such as the touch screen displays.

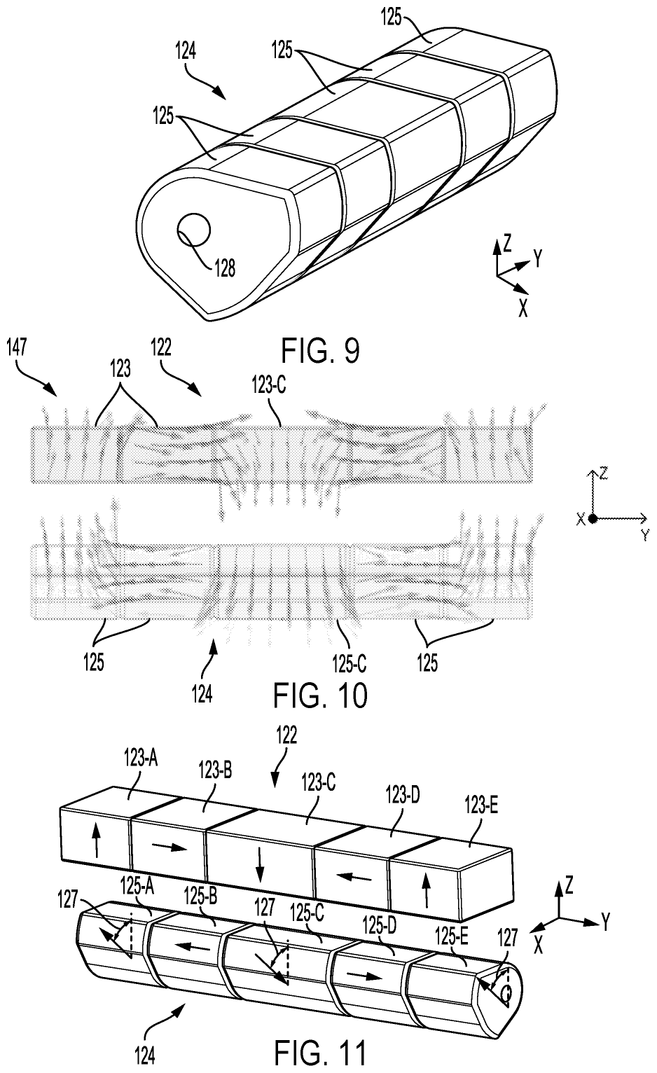

With continued reference to FIG. 2, as described in more detail below and in one potential advantage of this configuration, the second magnet assembly 124 comprises a plurality of second magnets 125 that are rotatably coupled to the second frame 114B via a spindle 130. As shown in FIGS. 2-5 and with reference also to FIG. 9, each of the second magnets 125 includes an aperture 128 extending in the y-axis direction through the magnet. The spindle 130 extends through the apertures 128 in each second magnet 125 to define an axis of rotation of the second magnets. In some examples, the second magnets 125 can freely spin about the spindle 130. As described further below, a cam 170, 172 is affixed to each end of the array of second magnets 125.

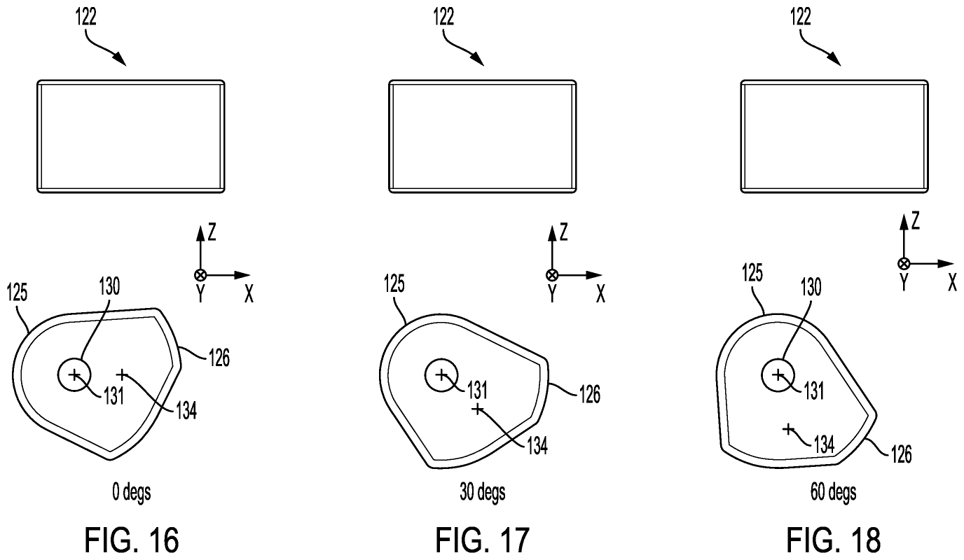

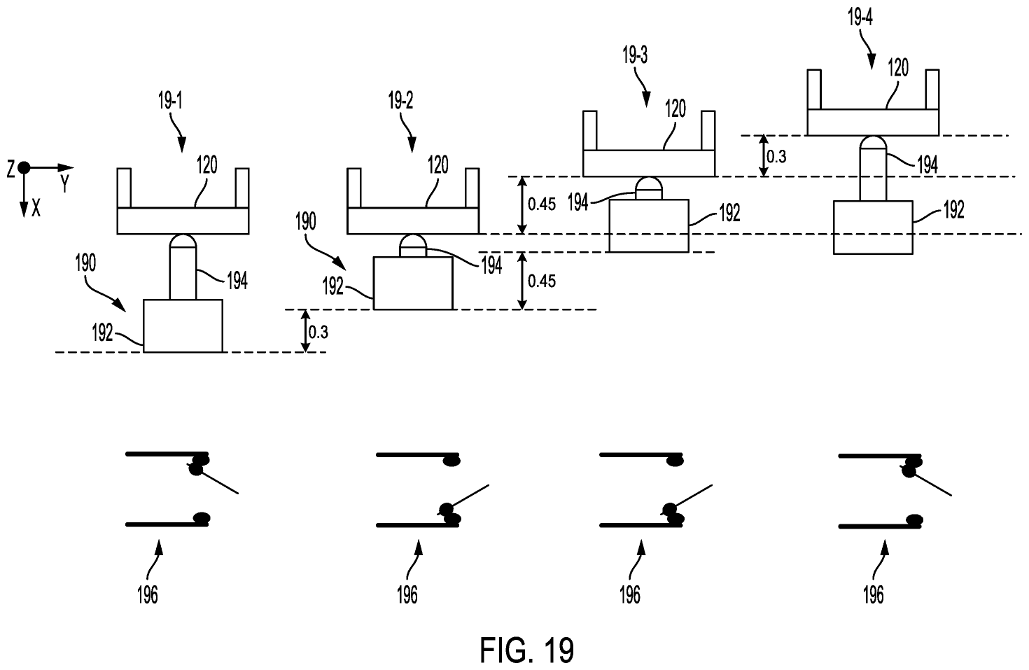

Additionally, as described in more detail below with reference to FIGS. 16-18 and in another potential advantage of this configuration, each of the second magnets 125 has an asymmetrical configuration in which the mass of the magnet is unevenly distributed with respect to the magnet's axis of rotation 131. In the present example, each of the second magnets 125 includes a lobe 126 that extends away from the axis of rotation. Accordingly, the center of mass 134 of each of the second magnets 125 is offset from its axis of rotation. In other examples, a wide variety of other asymmetrical shapes and volumes can be utilized for the second magnets 125. In some examples, each of the second magnets 125 has a center of mass that is coaxial with its axis of rotation.

As depicted in FIGS. 16-18 and described further below, with this configuration the center of mass 134 in each second magnet 125 moves further away from the first magnets 123 in the first magnet assembly 122 as the second magnet assembly 124 is rotated via actuation of the actuator 120. Advantageously, this configuration provides a faster drop off in the magnetic forces attracting the second magnet assembly 124 to the first magnet assembly 122 as compared to a symmetrical magnet structure rotated about a central axis of rotation. Additionally, and as described further below, this force profile can be utilized with one or more biasing members that bias the second magnet assembly 124 for rotation in an open direction to reduce the actuation force on the actuator 120 that is required from a user to rotate the second magnet assembly 124 and open the two frames.

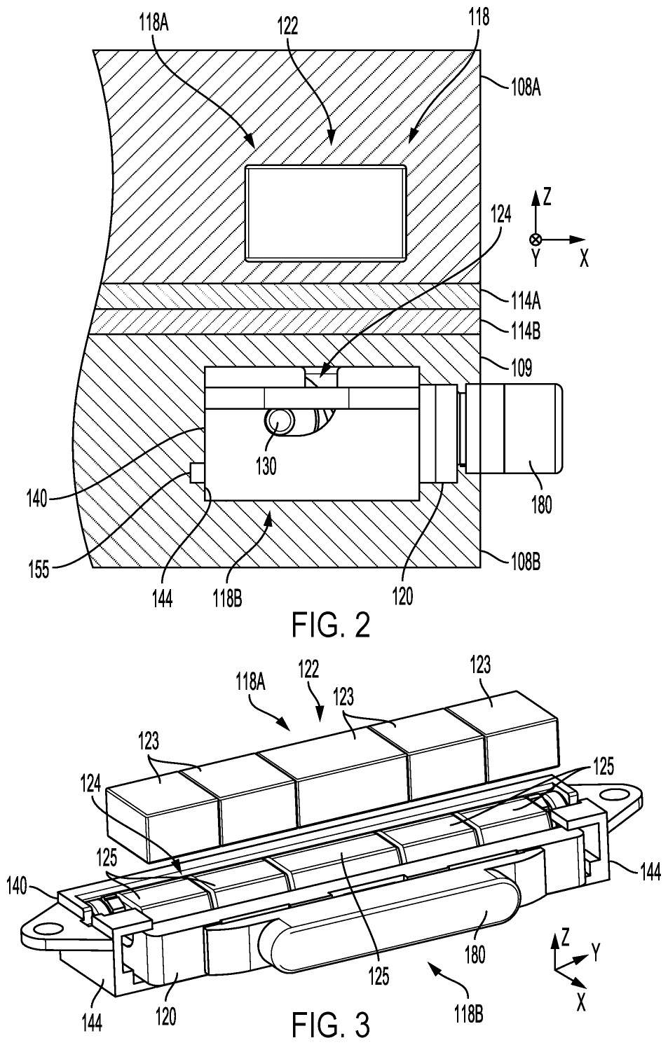

With reference now to FIGS. 2-3 and 9-11, the first magnet assembly 122 of first portion 118A of the apparatus 118 is affixed at a stationary position within the first frame 108A. As shown in FIGS. 3 and 9, in this example the first magnet assembly 122 and the second magnet assembly 124 are each comprised of five magnets. In other examples, any suitable number of magnets can be utilized. In some examples, a different number of magnets can be utilized in the first magnet assembly 122 and second magnet assembly 124.

In some examples, a plurality of magnets can be arranged into an array (e.g., a Halbach array) that provides a strong attractive force between the first magnet assembly and the second magnet assembly, and which provides the actuator with desirable force-stroke behavior. In the present example and with reference to FIGS. 10 and 11, the first magnets 123 of the first magnet assembly 122 are arranged in a Halbach array and the second magnets 125 of the second magnet assembly 124 are arranged in a Halbach array. In this example, each first magnet 123 in the first magnet assembly 122 overlies a corresponding second magnet 125 in the second magnet assembly 124, and each first magnet and its corresponding second magnet have approximately the same width in the y-axis direction. In other examples, one or more pairs of corresponding first magnets 123 and second magnets 125 can have different widths.

With reference to FIG. 11, each of the first magnets 123 and second magnets 125 is annotated with a directional arrow indicating a general orientation of each magnet's magnetic field. FIG. 10 shows a vector field diagram 147 schematically illustrating the magnetic fields of the first magnet assembly 122 and the second magnet assembly 124. Accordingly, and in one potential advantage of the present disclosure, the magnetic fields of one Halbach array are configured to augment the magnetic fields of the other array to generate a stronger attractive force between the first magnet assembly 122 and the second magnet assembly 124 when the first frame 108A and the second frame 108B are in the closed orientation.

Additionally, and in one potential advantage of the present disclosure, in one or more pairs of first magnets 123 and corresponding second magnets 125, the second magnet has a second magnetic field orientation that is offset from the first magnetic field orientation of the first magnet. In the present example and as illustrated in FIG. 11, the center first magnet 123-C has a center first magnetic field orientation in the negative z-axis direction, and a center second magnet 125-C of the plurality of second magnets 125 has a center second magnetic field orientation that is offset from the center first magnetic field orientation by an offset angle 127 with respect to the z-axis. Similarly, the left-most first magnet 123-A has a left-most first magnetic field orientation in the positive z-axis direction, and a left-most second magnet 125-A has a left-most second magnetic field orientation that is offset from the left-most first magnetic field orientation by the offset angle 127 with respect to the z-axis. Similarly, the right-most first magnet 123-E also has a right-most first magnetic field orientation in the positive z-axis direction, and a right-most second magnet 125-E has a right-most second magnetic field orientation that is offset from the right-most first magnetic field orientation by the offset angle 127 with respect to the z-axis.

In this manner, and as described in more detail below, by offsetting the magnetic field orientations of selected first and second magnet pairs, the attractive force between the first magnet assembly 122 and second magnet assembly 124 and corresponding closing torque exerted on the first cam 170 and second cam 172 in the closed direction (that resists rotation of the second magnet assembly in the open direction) can be tuned to provide a desired torque curve relative to the angle of rotation of the second magnet assembly. In some examples, the center second magnetic field orientation of the center second magnet 125-C is offset from the center first magnetic field orientation of the center first magnet 123-C by an offset angle 127 of at least 45 degrees. In one potential advantage of these configurations, and as described further below, these offsets of the magnetic field orientations in combination with the uneven distribution of magnets' mass with respect to their axis of rotation produces a decreasing closing torque exerted on the cams and second magnet assembly 124 in a closed direction opposite to the open direction as the second magnetic assembly is rotated from the closed configuration in the open direction.

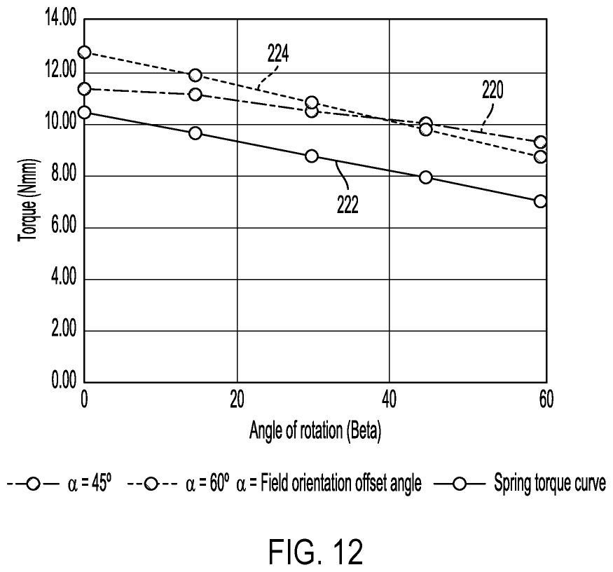

In one example, FIG. 12 shows two plots 220 and 224 of the closing torque about the center second magnet 125-C of the second magnet assembly 124 as a function of the assembly's rotation angle, with each plot corresponding to different offset angles 127 of the magnetic field orientation of the second magnet assembly. In this example, a first plot 220 corresponds to an offset angle 127 of 45 degrees. As illustrated, in this example the closing torque about the center second magnet 125-C steadily decreases from zero degrees to 60 degrees of rotation of the second magnet assembly 124. It will be appreciated that 60 degrees of rotation of the second magnet assembly 124 is merely one example configuration. In other examples, the second magnet assembly 124 is configured to rotate lesser or greater amounts to provide the functionality described herein.

The second plot 224 corresponds to an offset angle 127 of 60 degrees. As illustrated, in this example the closing torque about the center second magnet 125-C at zero degrees is initially greater than the torque of the example with the 45-degree offset, and the closing torque about the center second magnet at 60 degrees is less than the torque of the example with the 45-degree offset. Accordingly, with this configuration the closing torque steadily decreases from zero to 60 degrees of rotation of the second magnet assembly 124 at a greater rate than the configuration using a 45-degree offset. Also described further below, FIG. 12 illustrates a plot of a biasing torque 222 produced by one or more biasing members in the opening direction that opposes the closing torque of plots 220/224 of the first and second magnet assemblies 122, 124, thereby reducing the force required to rotate the second magnet assembly 124.

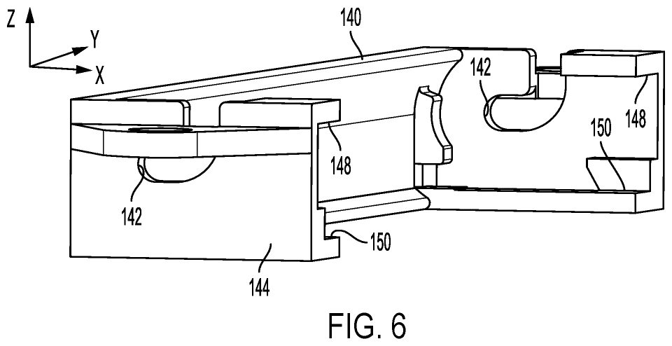

With reference again to FIGS. 2-7 and as noted above, the actuator 120 is operatively configured to rotate the second magnet assembly 124 to allow the first portion 118A of the apparatus 118 to disengage from the second portion 118B. In this example, the second portion 118B of apparatus 118 comprises an apparatus frame 140 that includes slots 142 in opposing sidewalls 144 of the frame (see FIG. 6). Opposing ends of the spindle 130 are rotatably captured within the slots 142 to enable the spindle to rotate.

On each end of the apparatus frame 140, an upper frame guide surface 148 and opposing lower frame guide surface 150 guide the actuator 120 for translation relative to the second frame 108B in the x-axis direction toward and away from the second magnet assembly 124. As shown in FIG. 5, at each end of the actuator 120 an upper actuator guide surface 152 and lower actuator sliding surface 154 are slidably captured between the upper frame guide surface 148 and opposing lower frame guide surface 150 of the apparatus frame 140 to enable translation of the actuator.

In another potential advantage of this configuration, the actuator 120 includes a first arm 155 extending from an elongated base 156 toward a first cam 170 that is affixed to the second magnet assembly 124. On its opposite end the actuator 120 includes a second arm 160 laterally spaced from the first arm 155 and extending from the elongated base 156 toward a second cam 172 that is also affixed to the second magnet assembly 124.

With reference now to FIGS. 5 and 13-15, the first arm 155 of the elongated base 156 comprises a first pusher surface 157 that contacts a first face 171 of the first cam 170 when the elongated base is translated toward the second magnet assembly 124. Similarly, the second arm 160 of the elongated base 156 comprises a second pusher surface 161 that contacts a second face 173 of the second cam 172 when the elongated base is translated toward the second magnet assembly 124.

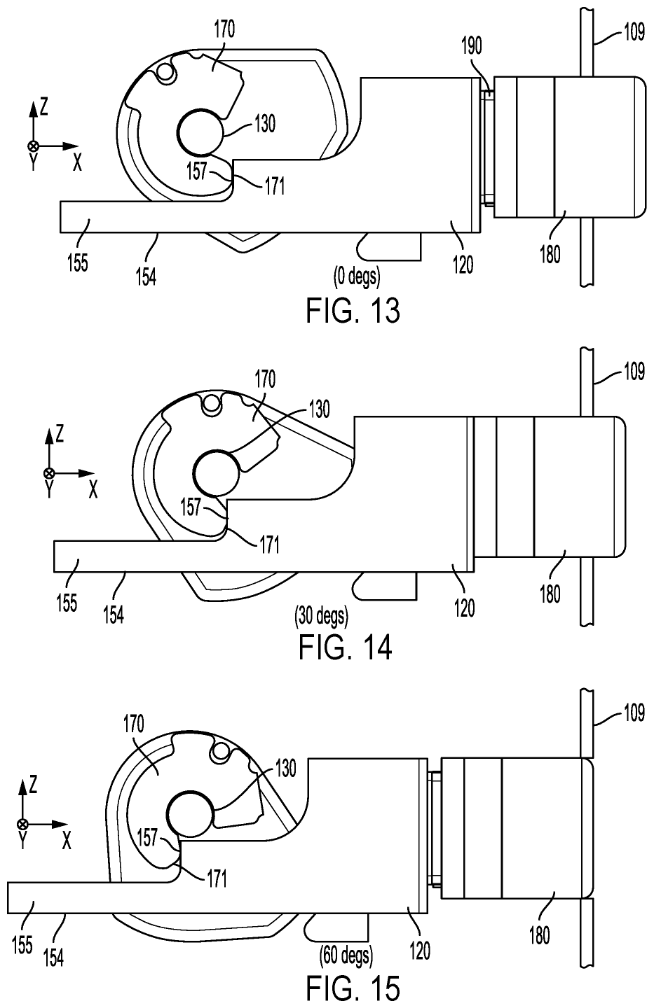

Accordingly, with this configuration and as shown in FIGS. 13-15, translation of the elongated base 156 toward the second magnet assembly 124 causes the first arm 155 to rotate the first cam 170 and the second arm 160 to rotate the second cam 172, thereby causing rotation of the second magnet assembly 124 in the open direction (clockwise about the y-axis in FIGS. 13-15) from the closed configuration (at zero degrees rotation). As described in more detail below, and in one potential advantage of this configuration, such rotation of the second magnet assembly 124 reduces a magnetic force between the first magnet assembly 122 and the second magnet assembly that allows the first frame 108A and the second frame 108B to rotate away from the closed configuration. Additionally, and in another potential advantage, by utilizing laterally spaced-apart first and second elongated arms 155, 160 and corresponding pusher surfaces 157, 161 to engage the first and second laterally spaced-apart cams 170, 172, this configuration locates the elongated arms very close to the spindle bearing surfaces, thereby significantly reducing the bending moment exerted on the spindle 130. In this manner, the reduced bending moment allows the size of spindle 130 to be significantly reduced, thereby allowing the second magnets 125 to have greater size and volume as well as reducing rotation friction of the spindle within slots 142. It will also be appreciated that in other configurations, translation of an elongated base toward a second magnet assembly causes rotation of the second magnet assembly in a counter-clockwise direction to reduce a magnetic force between a first magnet assembly and second magnet assembly that allows the first frame 108A and the second frame 108B to rotate away from the closed configuration.

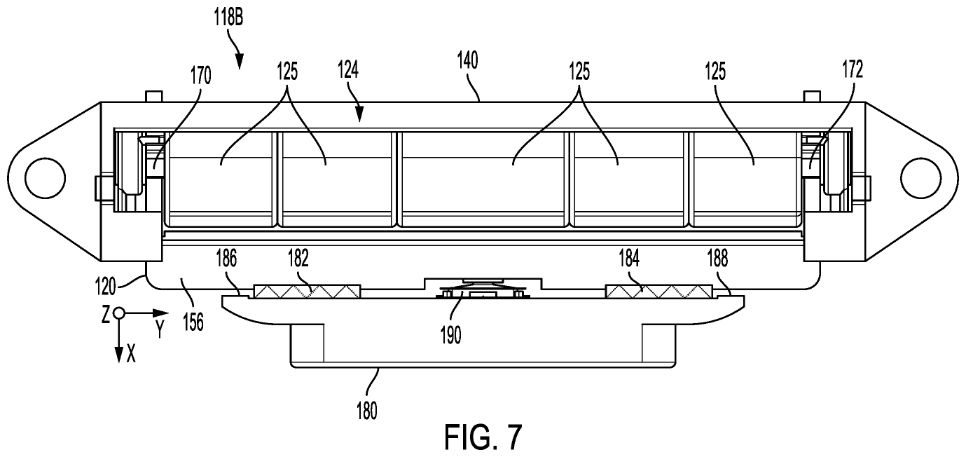

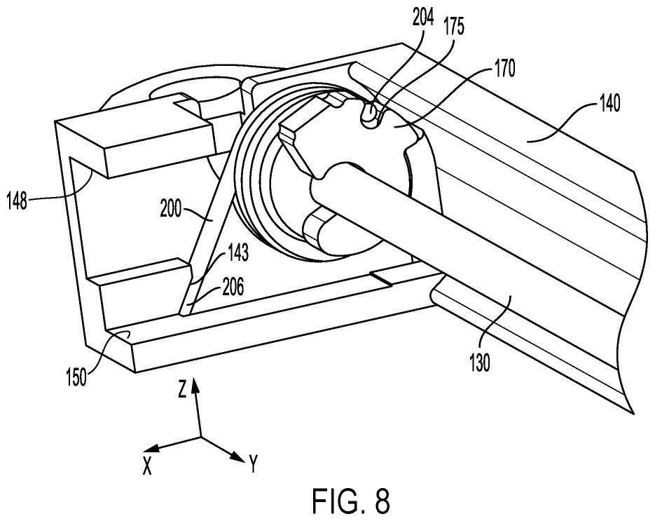

Additionally, and with reference to FIGS. 5 and 7, in this example the apparatus 118 includes a separate push-to-open (PTO) button 180 that is pressed by a user to translate the actuator 120 and rotate the second magnet assembly 124 to release the first frame 108A and second frame 108B from the closed configuration. As shown in FIGS. 2 and 13-15, the PTO button 180 protrudes through an aperture 111 defined in an end wall 109 of the second frame 108A. In this example and with reference again to FIGS. 5 and 7, a first resilient member 182 and a second resilient member 184 are located in a first recessed area 121 and second recessed area 129, respectively, that are defined in the elongated base 156 of the actuator 120. As shown in FIG. 7, in its non-actuated default position, the PTO button 180 is slightly spaced from the elongated base 156 by the first resilient member 182 and the second resilient member 184.

The PTO button 180 includes laterally spaced-apart contacting surfaces for contacting the elongated base 156. In this example, the PTO button 180 includes a first button contacting surface 186 configured to contact the elongated base 156 between the first arm 155 and the second arm 160, and a second button contacting surface 188 spaced from the first button contacting surface 186 and configured to contact the elongated base 156 between the first arm 155 and the second arm 160. As described further below, when a user presses the PTO button 180 in the negative x-axis direction, the first and second resilient members 182, 184 are compressed until the first and second button contacting surfaces 186, 188 contact and begin translating the actuator 120.

Further, and in another potential advantage of this configuration, the width between the first button contacting surface 186 and the second button contacting surface 188 is less than a width between the first pusher surface 157 and the second pusher surface 161 of the actuator 120. Accordingly, this configuration provides a stable actuation platform that provides translation along the x-axis while reducing or substantially eliminating rotation or yaw about the z-axis during actuation.

In some examples, apparatus of the present disclosure can include one or more additional buttons that are actuated by the PTO button 180. In the present example and with reference to FIGS. 5 and 7, a power button 190 is located between the elongated base 156 and the PTO button 180. As described further below, the PTO button 180 is configured to depress the power button 190 upon a user pressing the PTO button. In different configurations, the power button 190 is configured to cycle power to the foldable computing device 104 and/or perform one or more other functions. In the present example and as described in more detail below, the power button 190 comprises a normally-open, momentary contact switch, such as a snap dome or tactile dome switch. In other examples, a variety of other types and configurations of switches can be utilized.

As noted above, the apparatus 118 also includes biasing member that biases the second magnet assembly 124 for rotation in the open direction. In the present example and with reference to FIGS. 5 and 8, the biasing member comprises a first torsion spring 200 that engages the first cam 170 and the apparatus frame 140 to urge the second magnet assembly 124 to rotate in the open direction (clockwise as viewed along the positive y-axis). Similarly, a second torsion spring 210 engages the second cam 172 and the apparatus frame 140 to urge the second magnet assembly 124 to rotate in the open direction.

As shown in FIG. 8, the first torsion spring 200 includes a first end 204 that is captured and retained within a first notch 175 defined in the first cam 170. At the other end of the first torsion spring 200, a second end 206 engages a spring stop surface 143 on the apparatus frame 140. In this manner, the first torsion spring 200 operates to produce a biasing torque on the first cam 170 and the attached spindle 130 and second magnet assembly 124 in the open direction. The second torsion spring 210 is configured to engage the second cam 172 and apparatus frame 140 in a similar manner to urge the second magnet assembly 124 to rotate in the open direction.

Also as noted above in another potential advantage, the biasing torque in the open direction provided by first and second torsion springs 200, 210 is configured to coordinate with the force profile provided by the magnetic attraction between the first and second magnet assemblies 122, 124 (that creates a closing torque that opposes rotation in the open direction) in a manner that creates a lower-force actuation threshold for translating the PTO button/actuator and opening the first and second frames 108A, 108B. Additionally, and as described further below, the biasing torque and force profile of the magnet assemblies are configured to create a consistent resistance to translation of the PTO button 180/actuator 120 and corresponding rotation of the second magnet assembly 124 across the full translation/rotation, thereby providing the technical effects of facilitating a consistent actuation of the apparatus 118 and release of the first and second frames 108A, 108B from their closed orientation, and avoiding unintended actuations and releasing of the frames.

In some examples, the first and second torsion springs 200, 210 are configured to produce a biasing torque on the first cam 170 and second cam 172, respectively, in the open direction that is slightly below the opposing closing torque on the cams created by the magnetic attraction between the first and second magnet assemblies 122, 124. It will be appreciated that the difference between the biasing torque on the cams in the open direction and the opposing closing torque on the cams created by the first and second magnet assemblies 122, 124 corresponds the user-generated torque required to rotate the second magnet assembly 124. As noted above, these configurations create a lower-force actuation threshold for translating the PTO button/actuator. Additionally, and in another potential advantage of these configurations, the first and second magnet assemblies 122, 124 are configured to produce a closing torque exerted on the cams in the closed direction that remains above the biasing torque exerted on the cams by the first and second torsion springs 200, 210 in the open direction across the full translation/rotation of the apparatus 118. Advantageously and as noted above, these configurations create a consistent resistance to translation of the PTO button 180/actuator 120 and corresponding rotation of the second magnet assembly 124 across the full translation/rotation.

In one example and with reference now to FIGS. 12-15, the first and second cams 170, 172 and the second magnet assembly 124 are configured to rotate through 60 degrees from the closed configuration corresponding to FIG. 13 to the open configuration corresponding to FIG. 15. In other examples, the first and second cams 170, 172 and second magnet assembly 124 are configured to rotate through other ranges between the closed and open configurations, such as 30 degrees, 45 degrees, 75 degrees, or other suitable range. With reference to FIG. 12 and as noted above, two example torque profiles for two different magnetic field orientation offset angles 127 are shown. In the example where the first and second magnet assemblies 122, 124 are configured to produce a magnetic field orientation offset angle 127 of 45 degrees, a closing torque 220 decreases from approximately 11.2 Nmm at zero degrees rotation to approximately 9.4 Nmm at 60 degrees rotation.

FIG. 12 also illustrates a biasing torque 222 produced by the first and second torsion springs 200, 210 in the opening direction that opposes the closing torque 220 of the first and second magnet assemblies 122, 124, and also decreases from zero degrees rotation to the complete 60 degrees rotation. In this example, the closing torque 220 exerted on the first cam 170 and second cam 172 by the first and second magnet assemblies 122, 124 remains above the biasing torque 222 exerted on the cams by the first and second torsion springs 200, 210 in the open direction across the full 60 degrees of rotation of the second magnet assembly 124. Advantageously, this configuration provides resistance to rotation of the second magnet assembly 124 and corresponding resistance to translation of the PTO button 180 and actuator 120 in the negative x-axis direction across the full 60 degrees of rotation.

In the other example of FIG. 12, the first and second magnet assemblies 122, 124 are configured to produce a magnetic field orientation offset angle 127 of 60 degrees as described above. As shown in FIG. 12, this configuration produces a closing torque 224 that decreases from approximately 12.8 Nmm at zero degrees rotation to approximately 8.8 Nmm at 60 degrees rotation. Accordingly, this configuration produces a steeper reduction in closing torque from zero to 60 degrees rotation as compared to the example utilizing a magnetic field orientation offset angle 127 of 45 degrees. Advantageously, providing decreasing torque at a greater rate of change allows for a higher beginning closing torque and correspondingly more robust magnetic retention of the second magnet assembly 124 at zero degrees.

Additionally and as shown in FIG. 12, in this configuration the slope of the decreasing closing torque 224 more closely matches the slope of the decreasing biasing torque exerted on the cams by the first and second torsion springs 200, 210 in the open direction. In this manner, and in another potential advantage of this configuration, the net resistance to rotation of the second magnet assembly 124 and corresponding resistance to translation of the PTO button 180 and actuator 120 in the negative x-axis direction remains substantially constant across the full 60 degrees of rotation. Accordingly, this configuration provides a consistent resistance to actuation by the user via the PTO button 180, thereby providing a more uniform and pleasing user experience.

In some examples, with reference to FIGS. 5, 7, and 19-22 and as described in more detail below, where the power button 190 includes a normally-open switch with a non-zero stroke, the decompression of the switch can be utilized to provide a portion of the translation of the actuator 120 necessary to fully rotate the second magnet assembly 124. Accordingly, and in one potential advantage of this configuration, the required translation distance provided by the user via PTO button 180 is reduced, which correspondingly allows a corresponding reduction in the required protrusion distance of the PTO button 180 beyond the end wall 109 of the second frame 108A.

In one example and as schematically illustrated in FIG. 19, the power button 190 comprises a normally-open, momentary contact switch 196, such as a snap dome or tactile dome switch. The normally-open switch 196 utilizes a threshold switch force to close the switch. In one example, the power button 190 comprises a base 192 and a plunger 194. FIG. 19 schematically illustrates the power button 190, its switch 196, and the actuator 120 at different locations during user actuation of the power button. As described above, the first and second magnet assemblies 122, 124 are configured to produce a closing torque that is greater than the biasing torque produced by the first and second torsion springs 200, 210 across the full rotation of the second magnet assembly 124 (in this example, 60 degrees). Accordingly, the net torque produced in this configuration is converted to a resistance force exerted on the actuator 120 and PTO button 180 that opposes translation of these components in the negative x-axis direction.

Additionally, and as described further below, in this configuration the first and second magnet assemblies 122, 124 are configured to produce a closing torque that decreases at a faster rate than the reduction in biasing torque produced by the first and second torsion springs 200, 210. Further, this configuration produces a corresponding net torque/actuator resistance force that drops below the threshold switch force required to close the normally-open switch 196 prior to the full rotation of the second magnet assembly 124 at 60 degrees. At this point of transition, the compressed switch 196 decompresses and returns to its normally open position, thereby further translating the actuator 120 to further rotate the second magnet assembly 124 in the open direction without additional translation of the PTO button 180.

Advantageously and as described in more detail below, this configuration enables the decompression of the switch 196 to provide a portion of the translation of the actuator 120 necessary to fully rotate the second magnet assembly 124. This correspondingly reduces the required travel of the PTO button 180, allowing for a reduced protrusion of the PTO button from the end wall 109 of the second frame 108A.

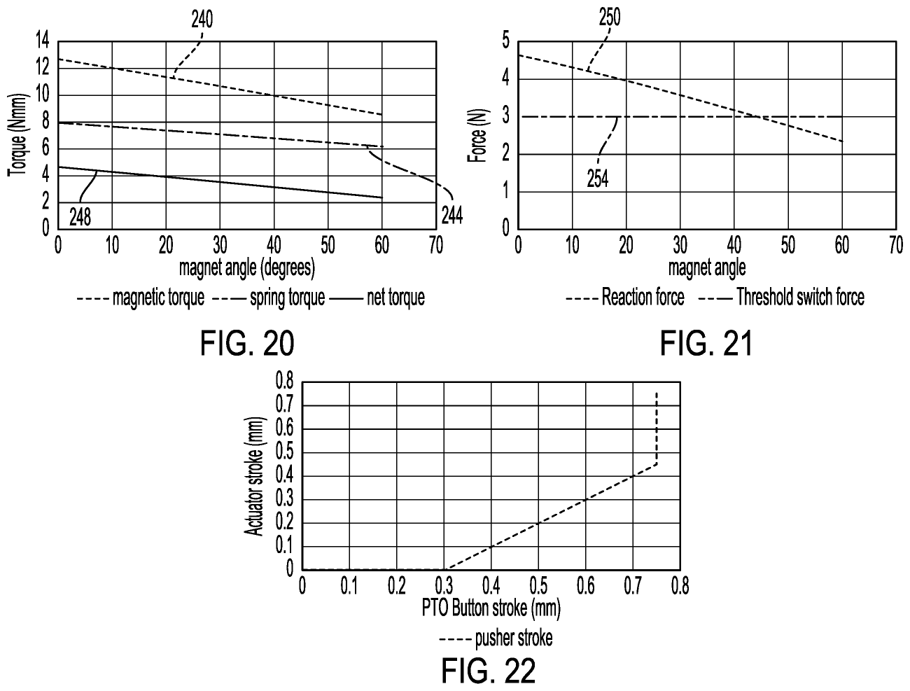

In one example, FIG. 20 shows a plot with representations of a closing torque 240 in the closed direction produced by the first and second magnet assemblies 122, 124, a biasing torque 244 in the open direction produced by the first and second torsion springs 200, 210, and a net torque 248 in the closed direction across the full rotation of the second magnet assembly 124 (in this example, 60 degrees). As shown in this example, the closing torque 240 decreases at a faster rate than the reduction in the biasing torque 244. Correspondingly and as noted above, the net torque 248 produced in this configuration also decreases over the range of rotation of the second magnet assembly 124.

With reference now to FIG. 21, the net torque 248 is converted to a reaction force 250 exerted by the first cam 170 and the second cam 172 on the first arm 155 and the second arm 160 of the actuator 120, respectively, and correspondingly transferred to the actuator 120 and PTO button 180 to oppose translation of these components in the negative x-axis direction. Accordingly, and like the net torque 248, the reaction force 250 decreases over the rotation of the second magnet assembly from zero to 60 degrees. In this example, the reaction force 250 decreases from approximately 4.7 N. at zero degrees to approximately 2.4 N. at 60 degrees. Also in this example, the threshold switch force 254 required to close the normally-open switch 196 is 3 N. Accordingly and as described further below, at approximately 45 degrees of rotation the reaction force 250 drops below the threshold switch force 254, thereby allowing the power button 190 to return to its normally-open position, which in turn moves the plunger 194 to further translate the actuator 120 and rotate the second magnet assembly 124 another 15 degrees (without additional translation of the PTO button 180).

With reference now to FIG. 22, a schematic representation of the translation of the PTO button 180 versus the translation of the actuator 120 (and corresponding rotation of the second magnet assembly 124) is illustrated. Also and as noted above, FIG. 19 schematically illustrates the power button 190, its switch 196, and the actuator 120 at different locations during user actuation of the power button via translation of the PTO button 180. As shown in FIG. 19, state 19-1 represents the power button 190 in an uncompressed state with its switch 196 in the normally-open position. With reference to FIGS. 13 and 16, this state 19-1 corresponds to the state prior to a user actuating the PTO button 180 where the second magnet assembly 124 (and first cam 170 and second cam 172) are at zero degrees rotation, and the PTO button 180 protrudes from the end wall 109 of the second frame 108B.

Returning to FIG. 19, state 19-2 represents the power button 190 in a compressed state in which the base 192 has translated by a switch actuation distance to close the switch 196. In this example, the switch actuation distance is 0.3 mm. In other examples, other switches having other switch actuation distances can be utilized. In this example, a user has pressed and translated the PTO button 180 by 0.3 mm in the negative x-axis direction to close the switch 196 and actuate the power button 190. As shown in FIG. 19, the actuator 120 remains in the same x-axis position as in state 19-1, with the translation of the PTO button 180 operating only to translate the power button base 192 and close the switch 196. This is also represented in FIG. 22, where the state 19-2 of FIG. 19 corresponds to a 0.3 mm PTO button stroke and no actuator stroke.

Returning to FIG. 19, between states 19-2 and 19-3 the user continues translating the PTO button 180 by an initial magnet rotation distance to correspondingly translate the actuator 120 by this distance and rotate the second magnet assembly 124 by an initial rotation of approximately 45 degrees. As shown in FIG. 19, the initial magnet rotation distance is 0.45 mm. In other examples, other initial magnet rotation distances and initial rotations can be utilized. This is also represented in FIG. 22, where translation between states 19-2 and 19-3 of FIG. 19 corresponds to an additional 0.45 mm PTO button stroke from 0.3 mm to 0.75 mm and a corresponding actuator stroke of 0.45 mm.

With reference now to FIG. 21 and as noted above, when the second magnet assembly 124 has rotated by the initial rotation of approximately 45 degrees, the reaction force 250 drops below the threshold switch force 254 of 3 N., thereby allowing the power button 190 to return to its normally-open position. This in turn moves the plunger 194 by the switch actuation distance of 0.3 mm to further translate the actuator 120 and rotate the second magnet assembly 124 another 15 degrees to its full rotation of 60 degrees. Accordingly, and in another potential advantage of this configuration, this final 0.3 mm translation of the actuator 120 is caused solely by the power button returning to its normally-open position, such that no additional translation of the PTO button 180 is needed. This is illustrated in FIG. 19 by the transition between states 19-3 and 19-4 where the base 192 of the power button 190 remains stationary and the plunger 194 translates the actuator 120 by the switch actuation distance of 0.3 mm.

With reference to FIG. 15, state 19-4 of FIG. 19 is also shown in which the power button 180 is flush with the end wall 109 of the second frame 108B. Advantageously, this configuration utilizes the power button's normally-open switch functionality to partially drive rotation of the second magnet assembly 124 via translation of the actuator 120. Accordingly, and as schematically depicted in FIG. 22, this configuration enables the PTO button 180 to translate a shorter distance to achieve both (1) actuation of the normally-open switch 196 and (2) rotation of the second magnet assembly 124 over the full 60 degrees.

With reference to FIGS. 13-15, it follows that the shorter required translation distance enables a corresponding reduction in the required protrusion of the PTO button 180 beyond the end wall 109 of the second frame 108B. Advantageously, such reduced protrusion also reduces exposure of the PTO button 180 to undesirable and accidental contact with external surfaces that could snag or catch the button and cause damage and/or unintended actuation of the button.

It will be appreciated that in different use case examples, the actuator 120, PTO button 180, and first and second cams 170, 172, can be sized and configured to accommodate different translation distances of the actuator that cause desired amounts of rotation of the second magnet assembly 124. In different examples, the distance of translation of the actuator 120 may be correlated to any other suitable rotational amount. In this manner, these components can be designed to cause the actuator to provide a suitable amount of magnet rotation that presents a pleasing user experience when opening the foldable device.

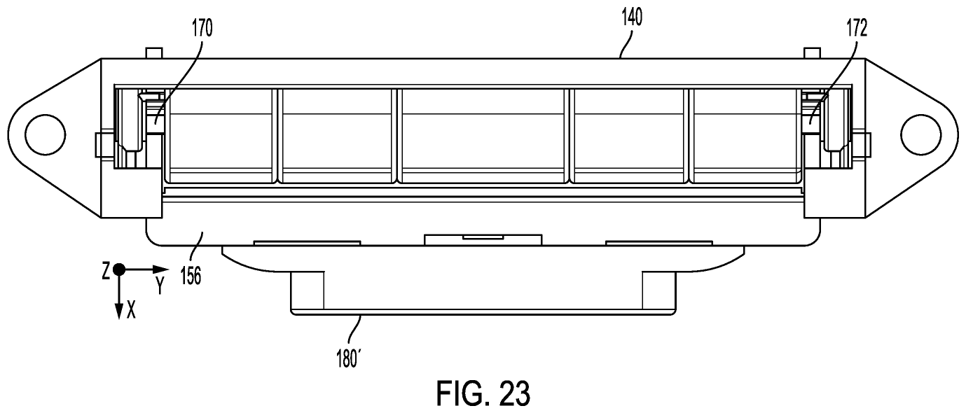

In some examples, a power button is not included between the PTO button and the actuator 120. In these examples, the PTO button can be integrated with or otherwise directly connected to the actuator. With reference now to FIG. 23, in one example of this configuration the elongated base 156 of the actuator 120 comprises an integrated PTO button 180′ that protrudes through the aperture defined in the side wall 109 of the second frame 108B of the device 104. In one potential advantage of this configuration, directly connecting the PTO button 180′ with the elongated base 156 can provide a more stable platform for user engagement with the button.

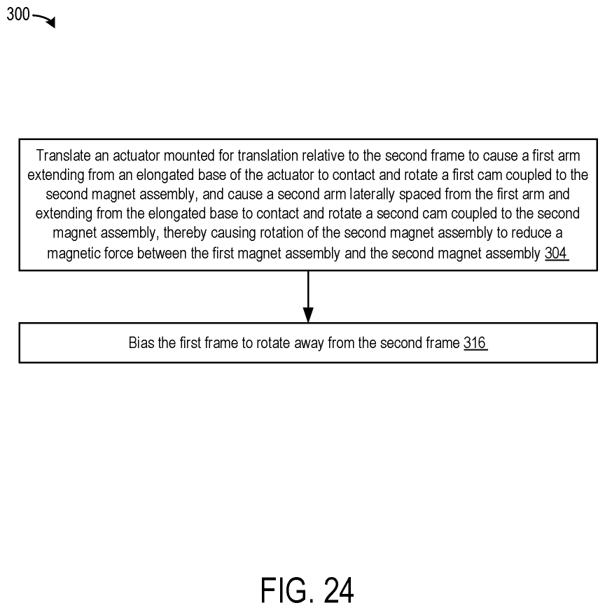

With reference now to FIG. 24, a flow diagram is provided depicting an example method 300 for opening a device from a closed configuration. The following description of method 300 is provided with reference to the components described herein and shown in FIGS. 1-23. The method 300 is performed at a device comprising a first frame comprising a first magnet assembly and a second frame rotatably coupled to the first frame and comprising a second magnet assembly. In some examples, the method 300 is performed at the foldable computing device 104 of FIGS. 1A-1D. In other examples, the method 300 is performed in other contexts using other suitable devices and components.

At 304, the method 300 includes translating an actuator mounted for translation relative to the second frame to cause a first arm extending from an elongated base of the actuator to contact and rotate a first cam coupled to the second magnet assembly, and cause a second arm laterally spaced from the first arm and extending from the elongated base to contact and rotate a second cam coupled to the second magnet assembly, thereby causing rotation of the second magnet assembly to reduce a magnetic force between the first magnet assembly and the second magnet assembly. At 308 the method 300 includes biasing the first frame to rotate away from the second frame.

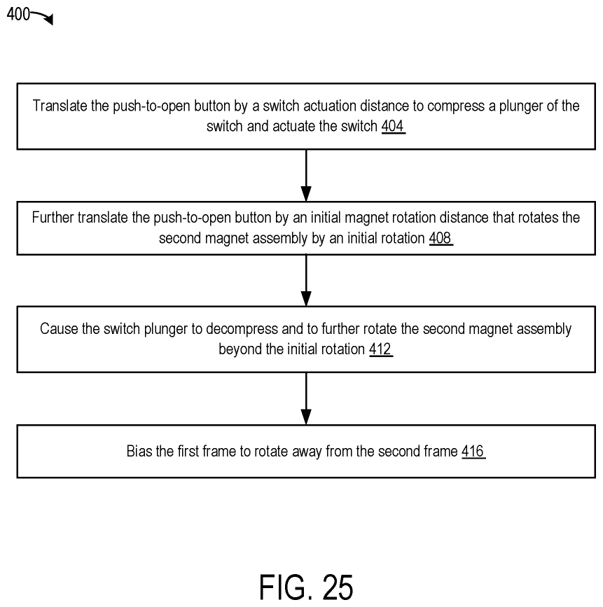

With reference now to FIG. 25, a flow diagram is provided depicting an example method 400 for opening a device from a closed configuration and actuating a switch in the device. The following description of method 400 is provided with reference to the components described herein and shown in FIGS. 1-22. The method 400 is performed at a device comprising a first frame comprising a first magnet assembly and a second frame rotatably coupled to the first frame and comprising a second magnet assembly, wherein a push-to-open button is moveably retained by the second frame. In some examples, the method 400 is performed at the foldable computing device 104 of FIGS. 1A-1D. In other examples, the method 400 is performed in other contexts using other suitable components.

At 404, the method 400 includes translating the push-to-open button by a switch actuation distance to compress a switch plunger and actuate the switch. At 408 the method 400 includes further translating the push-to-open button by an initial magnet rotation distance that rotates the second magnet assembly by an initial rotation. At 412 the method 400 includes causing the switch plunger to decompress and to further rotate the second magnet assembly beyond the initial rotation. At 416 the method 400 includes biasing the first frame to rotate away from the second frame.

The following paragraphs provide additional support for the claims of the subject application. One aspect provides an apparatus for allowing a device to open from a closed configuration, the device comprising a first frame comprising a first magnet assembly and a second frame rotatably coupled to the first frame, the apparatus comprising: a second magnet assembly rotatably coupled to the second frame, the second magnet assembly operatively configured to attract the first magnet assembly of the first frame when the first frame and the second frame are in the closed configuration; a biasing member biasing the second magnet assembly for rotation in an open direction; and an actuator mounted for translation relative to the second frame, the actuator comprising: a first arm extending from an elongated base toward a first cam coupled to the second magnet assembly; and a second arm laterally spaced from the first arm and extending from the elongated base toward a second cam coupled to the second magnet assembly; wherein translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly. The apparatus may additionally or alternatively include, wherein the elongated base comprises an integrated push-to-open button that protrudes through an aperture defined in a side wall of the second frame of the device. The apparatus may additionally or alternatively include a separate push-to-open button comprising: a first button contacting surface configured to contact the elongated base between the first arm and the second arm; and a second button contacting surface spaced from the first button contacting surface and configured to contact the elongated base between the first arm and the second arm. The apparatus may additionally or alternatively include a power button between the elongated base and the separate push-to-open button, wherein the separate push-to-open button is further configured to depress the power button. The apparatus may additionally or alternatively include, wherein the power button comprises a normally-open switch that a utilizes a threshold switch force to close the switch, wherein as the second magnet assembly rotates in the open direction to reduce the magnetic force between the first magnet assembly and the second magnet assembly, a reaction force exerted by the first cam and the second cam on the first arm and the second arm of the actuator, respectively, decreases below the threshold switch force, thereby causing the switch to return to its normally open position and translate the actuator to further rotate the second magnet assembly in the open direction. The apparatus may additionally or alternatively include, wherein the first arm of the elongated base comprises a first pusher surface that contacts a first face of the first cam when the elongated base is translated toward the second magnet assembly, and the second arm of the elongated base comprises a second pusher surface that contacts a second face of the second cam when the elongated base is translated toward the second magnet assembly. The apparatus may additionally or alternatively include, wherein the second magnet assembly comprises a plurality of second magnets, the apparatus further comprising a spindle extending through each of the second magnets along an axis of rotation of each of the second magnets, wherein each of the second magnets has a center of mass that is offset from its axis of rotation. The apparatus may additionally or alternatively include, wherein the first magnet assembly comprises a plurality of first magnets arranged in a Halbach array, the plurality of second magnets are arranged in a Halbach array, a center first magnet of the plurality of first magnets has a center first magnetic field orientation, and a center second magnet of the plurality of second magnets has a center second magnetic field orientation that is offset from the center first magnetic field orientation. The apparatus may additionally or alternatively include, wherein the center second magnetic field orientation is offset from the center first magnetic field orientation by at least 45 degrees. The apparatus may additionally or alternatively include, wherein as the second magnetic assembly is rotated from the closed configuration in the open direction, a closing torque exerted on the second magnet assembly in a closed direction opposite to the open direction decreases. The apparatus may additionally or alternatively include, wherein the closing torque exerted on the second magnet assembly in the closed direction remains above a biasing torque exerted on the second magnet assembly by the biasing member in the open direction as the first frame and the second frame are rotated away from the closed configuration. The apparatus may additionally or alternatively include, wherein the biasing member is a torsion spring, and the first cam defines a spring notch that captures a first end of the torsion spring. The apparatus may additionally or alternatively include, wherein the first magnet assembly is affixed at a stationary position within the first frame.

Another aspect provides foldable computing device, comprising: a first frame comprising a first magnet assembly; and a second frame rotatably coupled to the first frame via a hinge, the second frame comprising: a second magnet assembly rotatably coupled to the second frame, the second magnet assembly operatively configured to attract the first magnet assembly of the first frame when the first frame and the second frame are in a closed configuration; a biasing member biasing the second magnet assembly for rotation in an open direction; and an actuator mounted for translation relative to the second frame, the actuator comprising: a first arm extending from an elongated base toward a first cam coupled to the second magnet assembly; and a second arm laterally spaced from the first arm and extending from the elongated base toward a second cam coupled to the second magnet assembly; wherein translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly. The foldable computing device may additionally or alternatively include, wherein the elongated base comprises an integrated push-to-open button that protrudes through an aperture defined in a side wall of the second frame of the device. The foldable computing device may additionally or alternatively include a separate push-to-open button comprising: a first button contacting surface configured to contact the elongated base between the first arm and the second arm; and a second button contacting surface spaced from the first button contacting surface and configured to contact the elongated base between the first arm and the second arm. The foldable computing device may additionally or alternatively include a power button between the elongated base and the separate push-to-open button, wherein the separate push-to-open button is further configured to depress the power button. The foldable computing device may additionally or alternatively include, wherein the power button comprises a normally-open switch that a utilizes a threshold switch force to close the switch, wherein as the second magnet assembly rotates in the open direction to reduce the magnetic force between the first magnet assembly and the second magnet assembly, a reaction force exerted by the first cam and the second cam on the first arm and the second arm, respectively, of the actuator decreases at a reaction rate that is greater than a biasing rate at which a biasing force of the biasing member decreases, and the reaction force decreases below the threshold switch force, thereby causing the switch to return to its normally open position and translate the actuator to further rotate the second magnet assembly in the open direction. The foldable computing device may additionally or alternatively include, wherein the first arm of the elongated base comprises a first pusher surface that contacts a first face of the first cam when the elongated base is translated toward the second magnet assembly, and the second arm of the elongated base comprises a second pusher surface that contacts a second face of the second cam when the elongated base is translated toward the second magnet assembly.

Another aspect provides method for opening a device from a closed configuration, the device comprising a first frame comprising a first magnet assembly and a second frame rotatably coupled to the first frame and comprising a second magnet assembly, the method comprising: translating an actuator mounted for translation relative to the second frame to cause a first arm extending from an elongated base of the actuator to contact and rotate a first cam coupled to the second magnet assembly, and cause a second arm laterally spaced from the first arm and extending from the elongated base to contact and rotate a second cam coupled to the second magnet assembly, thereby causing rotation of the second magnet assembly to reduce a magnetic force between the first magnet assembly and the second magnet assembly; and biasing the first frame to rotate away from the second frame.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An apparatus for allowing a device to open from a closed configuration, the device comprising a first frame comprising a first magnet assembly and a second frame rotatably coupled to the first frame, the apparatus comprising:
a second magnet assembly rotatably coupled to the second frame, the second magnet assembly operatively configured to attract the first magnet assembly of the first frame when the first frame and the second frame are in the closed configuration;
a biasing member biasing the second magnet assembly for rotation in an open direction; and
an actuator mounted for translation relative to the second frame, the actuator comprising:
a first arm extending from an elongated base toward a first cam coupled to the second magnet assembly; and
a second arm laterally spaced from the first arm and extending from the elongated base toward a second cam coupled to the second magnet assembly;
wherein translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly.

2. The apparatus of claim 1, wherein the elongated base comprises an integrated push-to-open button that protrudes through an aperture defined in a side wall of the second frame of the device.

3. The apparatus of claim 1, further comprising a separate push-to-open button comprising:
a first button contacting surface configured to contact the elongated base between the first arm and the second arm; and
a second button contacting surface spaced from the first button contacting surface and configured to contact the elongated base between the first arm and the second arm.

4. The apparatus of claim 3, further comprising a power button between the elongated base and the separate push-to-open button, wherein the separate push-to-open button is further configured to depress the power button.

5. The apparatus of claim 4, wherein the power button comprises a normally-open switch that a utilizes a threshold switch force to close the switch, wherein as the second magnet assembly rotates in the open direction to reduce the magnetic force between the first magnet assembly and the second magnet assembly, a reaction force exerted by the first cam and the second cam on the first arm and the second arm of the actuator, respectively, decreases below the threshold switch force, thereby causing the switch to return to its normally open position and translate the actuator to further rotate the second magnet assembly in the open direction.

6. The apparatus of claim 1, wherein the first arm of the elongated base comprises a first pusher surface that contacts a first face of the first cam when the elongated base is translated toward the second magnet assembly, and the second arm of the elongated base comprises a second pusher surface that contacts a second face of the second cam when the elongated base is translated toward the second magnet assembly.

7. The apparatus of claim 1, wherein the second magnet assembly comprises a plurality of second magnets, the apparatus further comprising a spindle extending through each of the second magnets along an axis of rotation of each of the second magnets, wherein each of the second magnets has a center of mass that is offset from its axis of rotation.

8. The apparatus of claim 7, wherein the first magnet assembly comprises a plurality of first magnets arranged in a Halbach array, the plurality of second magnets are arranged in a Halbach array, a center first magnet of the plurality of first magnets has a center first magnetic field orientation, and a center second magnet of the plurality of second magnets has a center second magnetic field orientation that is offset from the center first magnetic field orientation.

9. The apparatus of claim 8, wherein the center second magnetic field orientation is offset from the center first magnetic field orientation by at least 45 degrees.

10. The apparatus of claim 1, wherein as the second magnetic assembly is rotated from the closed configuration in the open direction, a closing torque exerted on the second magnet assembly in a closed direction opposite to the open direction decreases.

11. The apparatus of claim 10, wherein the closing torque exerted on the second magnet assembly in the closed direction remains above a biasing torque exerted on the second magnet assembly by the biasing member in the open direction as the first frame and the second frame are rotated away from the closed configuration.

12. The apparatus of claim 1, wherein the biasing member is a torsion spring, and the first cam defines a spring notch that captures a first end of the torsion spring.

13. The apparatus of claim 1, wherein the first magnet assembly is affixed at a stationary position within the first frame.

14. A foldable computing device, comprising:
a first frame comprising a first magnet assembly; and
a second frame rotatably coupled to the first frame via a hinge, the second frame comprising:
a second magnet assembly rotatably coupled to the second frame, the second magnet assembly operatively configured to attract the first magnet assembly of the first frame when the first frame and the second frame are in a closed configuration;
a biasing member biasing the second magnet assembly for rotation in an open direction; and
an actuator mounted for translation relative to the second frame, the actuator comprising:
a first arm extending from an elongated base toward a first cam coupled to the second magnet assembly; and
a second arm laterally spaced from the first arm and extending from the elongated base toward a second cam coupled to the second magnet assembly;
wherein translation of the elongated base toward the second magnet assembly causes the first arm to rotate the first cam and the second arm to rotate the second cam, thereby causing rotation of the second magnet assembly in the open direction to reduce a magnetic force between the first magnet assembly and the second magnet assembly.

15. The foldable computing device of claim 14, wherein the elongated base comprises an integrated push-to-open button that protrudes through an aperture defined in a side wall of the second frame of the device.

16. The foldable computing device of claim 14, further comprising a separate push-to-open button comprising:
a first button contacting surface configured to contact the elongated base between the first arm and the second arm; and
a second button contacting surface spaced from the first button contacting surface and configured to contact the elongated base between the first arm and the second arm.

17. The foldable computing device of claim 16, further comprising a power button between the elongated base and the separate push-to-open button, wherein the separate push-to-open button is further configured to depress the power button.

18. The foldable computing device of claim 17, wherein the power button comprises a normally-open switch that a utilizes a threshold switch force to close the switch, wherein as the second magnet assembly rotates in the open direction to reduce the magnetic force between the first magnet assembly and the second magnet assembly, a reaction force exerted by the first cam and the second cam on the first arm and the second arm, respectively, of the actuator decreases at a reaction rate that is greater than a biasing rate at which a biasing force of the biasing member decreases, and the reaction force decreases below the threshold switch force, thereby causing the switch to return to its normally open position and translate the actuator to further rotate the second magnet assembly in the open direction.

19. The foldable computing device of claim 14, wherein the first arm of the elongated base comprises a first pusher surface that contacts a first face of the first cam when the elongated base is translated toward the second magnet assembly, and the second arm of the elongated base comprises a second pusher surface that contacts a second face of the second cam when the elongated base is translated toward the second magnet assembly.

20. A method for opening a device from a closed configuration, the device comprising a first frame comprising a first magnet assembly and a second frame rotatably coupled to the first frame and comprising a second magnet assembly, the method comprising:
translating an actuator mounted for translation relative to the second frame to cause a first arm extending from an elongated base of the actuator to contact and rotate a first cam coupled to the second magnet assembly, and cause a second arm laterally spaced from the first arm and extending from the elongated base to contact and rotate a second cam coupled to the second magnet assembly, thereby causing rotation of the second magnet assembly to reduce a magnetic force between the first magnet assembly and the second magnet assembly; and
biasing the first frame to rotate away from the second frame.

21. A method for opening a device from a closed configuration and actuating a switch in the device, the device comprising a first frame comprising a first magnet assembly and a second frame rotatably coupled to the first frame and comprising a second magnet assembly, wherein a push-to-open button is moveably retained by the second frame, the method comprising:
translating the push-to-open button by a switch actuation distance to compress a plunger of the switch and actuate the switch;
further translating the push-to-open button by an initial magnet rotation distance that rotates the second magnet assembly by an initial rotation;
causing the switch plunger to decompress and to further rotate the second magnet assembly beyond the initial rotation; and
biasing the first frame to rotate away from the second frame.
